(19) United States
(12) Patent Application Publication
(10) Pub. No.: US 2022/0058669 A1
(43) Pub. Date: Feb. 24, 2022

(54) METHOD AND SYSTEM FOR FORECASTING DEMAND WITH RESPECT TO AN ENTITY

(71) Applicant: PANASONIC INTELLECTUAL PROPERTY MANAGEMENT CO., LTD., Osaka (JP)

(72) Inventors: Yongning Yin, Singapore (SG); Debdeep Paul, Singapore (SG); Yizhou Huang, Singapore (SG); Khai Jun Kek, Singapore (SG)

(21) Appl. No.: 17/001,025

(22) Filed: Aug. 24, 2020

(51) Int. Cl. G06Q 30/02; G06N 20/00

(52) U.S. Cl. CPC G06Q 30/0202; G06N 20/00

(57) ABSTRACT

Method and system is disclosed for forecasting demand with respect to an entity. The method comprises receiving a plurality of input data-sets associated with time-series data, wherein each of said data-sets refers a time-based variation of one or more variables in accordance with a designated time-interval. At least one transformation-result is generated by transforming time-intervals of at least one input dataset based on a plurality of time interval transformation models. A plurality of first intermediate forecast results are predicted based on a plurality of demand forecasting models from the at-least one transformation result. An aggregated result is generated from the plurality of the first intermediate forecast results through an ensemble-model to thereby render said aggregated result as a final prediction result.

### TECHNICAL FIELD

The present subject matter relates to electronic-computing systems and in particular relates to data forecasts in predictive-analytics environment.

### BACKGROUND

Machine-learning (ML) models have been developed as predictive analysis criteria for drawing predictions such as sales-forecast. Such models usually receive input data set of time series index data comprising independent, predictable variables (e.g. historical sales) as input to forecast the sales of target product, wherein the sales of target product acts as a predicted-variable. Likewise, the state of the art examples may be construed to cover other indicia such as production, manufacturing, inflation, price etc.

At least a constraint associated with existing predictive analytics is requirement of the set of input index data in uniform timescale. For example, all input data are recorded in monthly base to forecast monthly sales of target product. This may be quite a restrictive requirement especially since multiple index data may be recorded in heterogonous time scales. For example, GDP index is commonly recorded in quarterly, PMI in monthly, while IHS Market car data in mixed of monthly, quarterly, and yearly.

The state of the art predictive-analytics do not substantially utilize all the valuable data in one model for the forecast and accordingly and employ different models based on different timescales. In an example of state of the art predictive analytics as depicted in FIG. 1a, waveforms are based on identical time-series values of historically captured objective variables as earlier measured. Waveforms among the plurality of waveforms are classified into one pattern based on similarity and a characteristic common to the waveforms included in the one pattern is set as an explanatory variable. The plurality of time series patterns are integrated and an index ID is generated for searching the integrated time series patterns at high speed. In addition, data is generated that manages transitions between integrated time series patterns. At-least based on said index and data described above, it is possible to predict the trend of an event in real-time with high prediction accuracy.

As a part of another example state of the art predictive analysis, a time interval of the time-series data is selected from a group consisting of the time intervals of the data sets. The method further includes “down-sampling” the observations of the first data set, and converting the time interval of the first data set to the time interval of the time-series data. Overall, this disclosure refers determining time interval of input data, perform down-sampling, feature engineering, and forecasting results.

However, said state of art techniques fail to perform optimized forecast in respect of heterogeneous time-scale inputs, i.e. input from different timescales or lower timescale data forecast. Such example heterogeneous time-scale inputs (monthly, yearly, mixed) have been depicted in FIG. 1b. In other words, the state of the art mechanisms fail to accept heterogeneous timescale (time granularity) data as input as a part of drawing forecast.

Even if example disclosure related to the down sampling and feature engineering is concerned, the same at-least fails to refer any time series or time domain based up-scaling of data-transform.

Overall, the state of the art predictive analytics and forecast models do not perform sales forecast by accepting heterogeneous timescale (time granularity) data as input and accordingly fall substantially short of maximizing the use of valuable information to obtain improved sales.

### SUMMARY

This summary is provided to introduce a selection of concepts in a simplified format that is further described in the detailed description of the present disclosure. This summary is neither intended to identify key inventive concepts of the disclosure nor is it intended for determining the scope of the invention or disclosure.

In an embodiment, the present subject matter refers a method for forecasting demand with respect to an entity. The method comprises receiving a plurality of input data-sets associated with time-series data, wherein each of said data-sets refers a time-based variation of one or more variables in accordance with a designated time-interval. At least one transformation-result is generated by transforming time-intervals of at least one input dataset based on a plurality of time interval transformation models. A plurality of first intermediate forecast results are predicted based on a plurality of demand forecasting models from the at-least one transformation result. An aggregated result is generated from the plurality of the first intermediate forecast results through an ensemble-model to thereby render said aggregated result as a final prediction result.

In another embodiment, the present subject matter refers a method for forecasting for time-series based dataset. The method comprises receiving a plurality of input data-sets associated with time-series data, wherein each of said data set refers a time-based variation of one or more variables in accordance with a designated time-scale. A time-scale of at-least one of said plurality of data sets is transformed based on at least one time-scale transformation model to generate at-least one transformed dataset. A plurality of intermediate prediction results are generated based on a plurality of demand forecasting models from at-least one transformed dataset, and at least one input data set other than the transformed data set. Further, an aggregated prediction-result is generated from the plurality of the intermediate prediction results based on an ensemble-learning model.

The objects and advantages of the embodiments will be realized and achieved at-least by the elements, features, and combinations particularly pointed out in the claims. It is to be understood that both the foregoing general description and the following detailed description are representative and explanatory and are not restrictive of the invention, as claimed.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 (a and b) illustrates state of the art scenario, in accordance with an embodiment of the present subject matter;

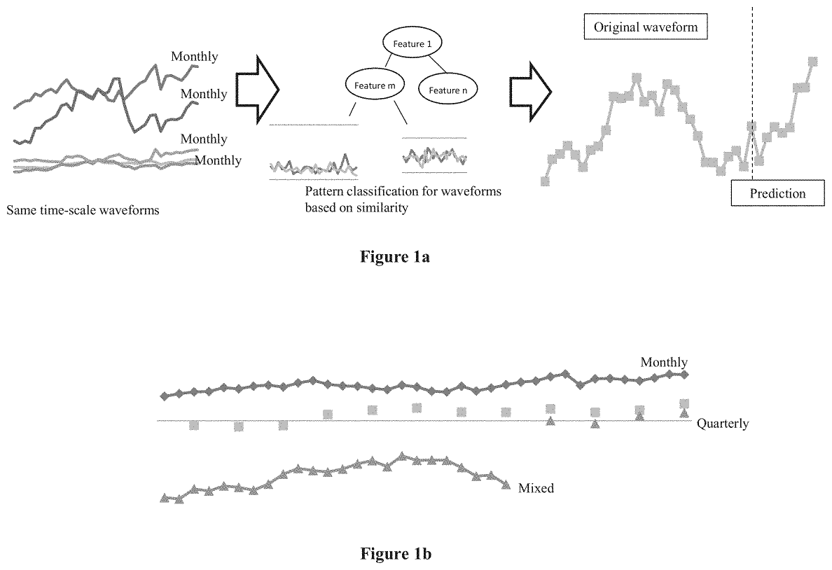

FIG. 2 illustrates method steps for data forecast, in accordance with an embodiment of the present subject matter;

FIG. 3 illustrates method steps for data forecast, in accordance with another embodiment of the present subject matter;

FIG. 4 illustrates example-implementation of the method steps, in accordance with an embodiment of the present subject matter;

FIG. 5 illustrates an example implementation of the method steps, in accordance with an embodiment of the present subject matter;

FIG. 6 illustrates a further example implementation of the method steps of FIG. 2 and FIG. 3, in accordance with an embodiment of present subject matter;

FIG. 7 illustrates an example representation depicting transformation module, in accordance with another embodiment of the present subject matter;

FIG. 8 illustrates another example representation depicting transformation module, in accordance with another embodiment of the present subject matter;

FIG. 9 illustrates another example illustration depicting forecast module, in accordance with another embodiment of the present subject matter;

FIG. 10 illustrates another example illustration depicting ensemble learning module, in accordance with another embodiment of the present subject matter;

FIG. 11 illustrates another example illustration depicting ensemble learning module, in accordance with another embodiment of the present subject matter;

FIG. 12 illustrates another example illustration depicting a final forecast outcome, in accordance with another embodiment of the present subject matter;

FIG. 13 illustrates an implementation in a computing environment, in accordance with another embodiment of the present subject matter.

The elements in the drawings are illustrated for simplicity and may not have been necessarily been drawn to scale. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF SOME EXAMPLE EMBODIMENTS

For the purpose of promoting an understanding of the principles of the present disclosure, reference will now be made to the embodiment illustrated in the drawings and specific language will be used to describe the same. It will be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

The foregoing general description and the following detailed description are explanatory of the present disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or subsystems or elements or structures or components proceeded by “comprises . . . a” does not, without more constraints, preclude the existence of other devices or other subsystems or other elements or other structures or other components or additional devices or additional subsystems or additional elements or additional structures or additional components.

Unless otherwise defined, all technical and scientific terms used herein have the same meaning as commonly understood by one of ordinary skill in the art to which this present disclosure belongs. The system, methods, and examples provided herein are illustrative only and not intended to be limiting.

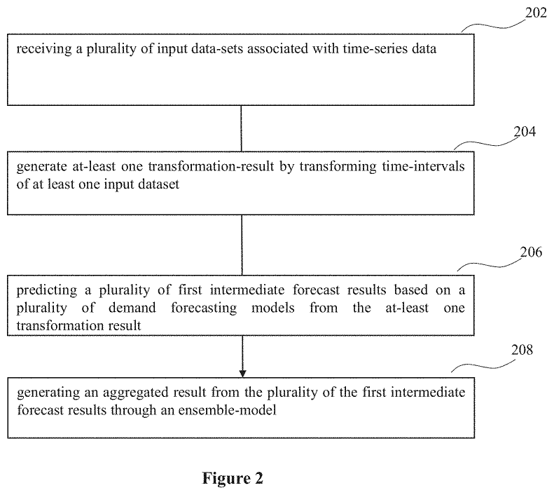

FIG. 2 illustrates a method for forecasting demand with respect to an entity. The method comprises receiving (step 202) a plurality of input data-sets associated with time-series data, wherein each of said data-sets refers a time-based variation of one or more variables in accordance with a designated time-interval. In an example, the input-dataset is a set of distinct time-interval based data sets defined by a first input dataset and a second input dataset, wherein the second input dataset has a larger time-interval than the first dataset and accordingly defines a lower time granularity than the first data set. The first input data set comprises a plurality of learning data points and a plurality of validation data points, such that the plurality of time interval transformation models predict a plurality of intermediate transformation results based on the plurality of training data points, the plurality of validation data points. The first input dataset and second data set related to different timescales correspond to one or more of a monthly index, a quarterly index, a yearly index, any miscellaneous time-scale index.

Further, the method comprises generating (step 204) at-least one transformation-result by transforming time-intervals of at least one input dataset based on a plurality of time interval transformation models. The transformation of the time-intervals of the input data-set comprises unifying the time-intervals across the time intervals of the input dataset based on the plurality of time-interval transformation models. The transforming comprises transforming a time interval of the second input dataset similar to a time interval of the first input dataset based on the plurality of time interval transformation models. In an implementation, the transformation result is predicted as an ensemble-model result from the plurality of intermediate transformation results using one or more functions of error values of the plurality of training data points, the error values of the plurality of validation data points, and the second input dataset.

Further, the method comprises predicting (step 206) a plurality of first intermediate forecast results based on a plurality of demand forecasting models from the at-least one transformation result. In an implementation, the plurality of demand prediction models predicts the plurality of first intermediate forecast results based on at-least one of: the transformation result and a third-input dataset having the same or different time interval than the transformation result.

Further, the method comprises generating (step 208) an aggregated result from the plurality of the first intermediate forecast results through an ensemble-model to thereby render said aggregated result as a final prediction result. In an implementation, the prediction of the aggregated result to render the final prediction result based on the ensemble model comprises the steps of a) selecting a plurality of second intermediate forecast results from the plurality of first intermediate forecast results; and b) generating the aggregated result by combining the plurality of second intermediate prediction results. More specifically, the aggregated result is generated from the plurality of the first intermediate forecast results through an ensemble-model to thereby render said aggregated result as a final prediction result.

In an example, such selecting of the plurality of second intermediate prediction results comprises generating a first type of distribution for each time interval from the plurality of first intermediate forecast results. Optionally, a second type of distribution is also generated from the first distribution. Based on said first or second distribution, the second intermediate forecast results are selected from the plurality of first intermediate prediction results based on one or more of: a training error, a validation error, derivatives of said training and validation errors comprising an error variance, said errors and derivatives being associated with the plurality of first intermediate prediction results. In an example, first intermediate prediction results may also be based on an objective optimization function of said training error, said validation error, the derivations of the training error and the validation error, and combinations thereof associated with the plurality of first intermediate prediction results.

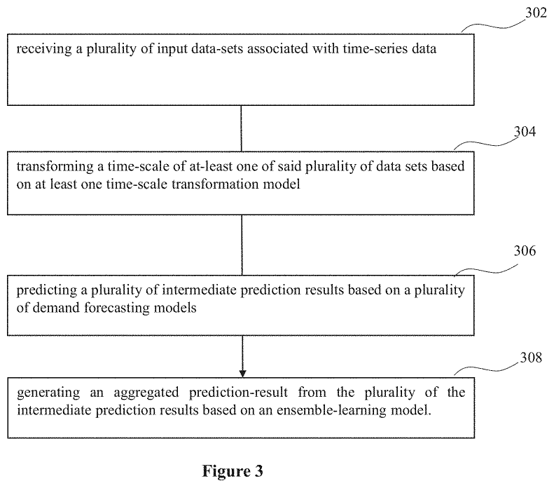

FIG. 3 illustrates a method for forecasting time-series based dataset in accordance with another embodiment of the subject matter. The method comprises receiving (302) a plurality of input data-sets associated with time-series data, wherein each of said data set refers a time-based variation of one or more variables in accordance with a designated time-scale.

The method further comprises transforming (step 304) a time-scale of at-least one of said plurality of data sets based on at least one time-scale transformation model to generate at-least one transformed dataset. The at-least one transformed dataset is associated with a higher time scale out of the heterogeneous time-scales associated with the received input data-sets and accordingly defines a higher time granularity among the heterogeneous time-scales associated with the received input data-sets. The transforming of the time-scale of the at least one input data set through the transformation model comprises executing a first plurality of machine-learning and time series models over the at least one input data set to obtain a plurality of intermediate transformation data sets. In addition, an ensemble-learning model is executed for aggregating the plurality of intermediate transformation data sets set to obtain an aggregated output as said at-least one transformed data set.

The method further comprises predicting (step 306) a plurality of intermediate prediction results based on a plurality of demand forecasting models from at-least one transformed dataset; and at least one input data set other than the transformed data set. The predicting of plurality of intermediate prediction results from the transformed data set comprises executing a second plurality of machine-learning and time series models over the at least one transformed data set and the at least one input data set to obtain said intermediate prediction results.

The method further comprises generating an aggregated prediction-result (step 308) from the plurality of the intermediate prediction results based on an ensemble-learning model. The generation of an aggregated prediction-result based on the ensemble-learning model comprises selecting at least a subset said intermediate prediction results based on any function of training error, validation error, derivatives of said errors, combinations thereof, and a percentile setting associated with said second plurality of machine learning models and time series models. Thereafter, a high time scale ensembled forecast and a low time scale ensembled forecast are generated from the selected prediction result. Further, a final high time-scale forecast result is generated based on adjustment of the high time scale ensembled forecast by the low time scale ensembled forecast.

In an example, such generating of said final high time-scale forecast result comprises integrating the high time scale ensembled forecast into a corresponding low-time scale ensembled forecast. One or more weights are determined based on any function of one or more of a training error, a validation error, the derivatives, the combinations thereof associated with the second plurality of machine learning models and time series models. Thereafter, the high time scale ensembled forecast is adjusted based on one or more low time scale ensembled forecasts and said one or more weights. Accordingly, the final high time-scale forecast is generated as the adjusted high time scale ensembled forecast.

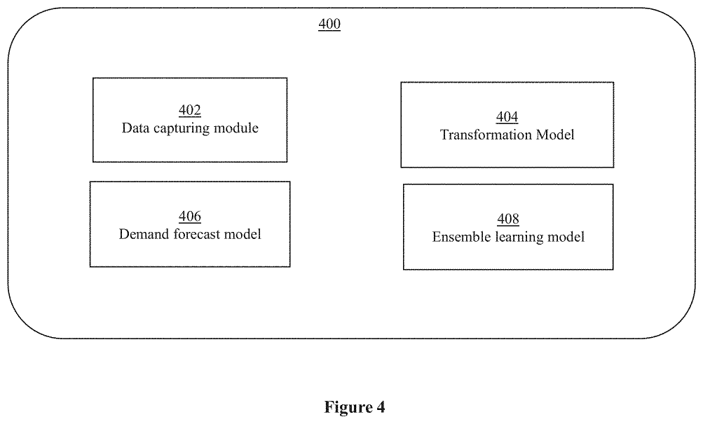

FIG. 4 illustrates a schematic-architecture for forecasting in a working computing environment. The architecture comprises a data-capturing module 402 executing the method step 202, 302. A transformation module 404 executes the computational-steps 204, 304. A demand forecasting module 406 executes the steps 206, 306. An ensemble learning module 408 executes the step 208, 308. A miscellaneous module 410 provides a user interface for receiving user input during the operation and operational interaction among the modules 402, 404, 406 and 408

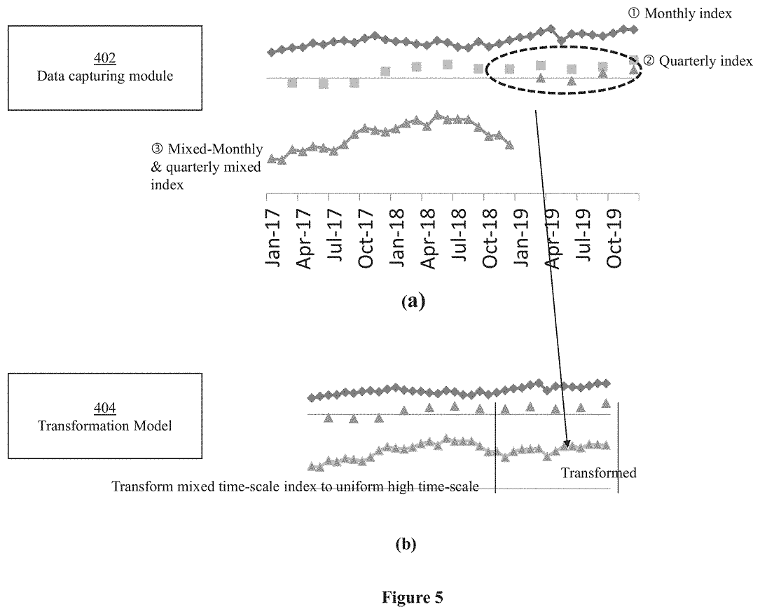

FIG. 5 illustrates the modules 402 and 404 as illustrated in FIG. 4. More specifically, the data capturing module 402 executing the steps 202, 302 depicted in FIG. 5 receives the input data defined by heterogeneous time-scale indexes and target product time series data. Input data or index data may have lower time granularity than target product.

The input index data may have mixed time-scale interval, e. g, with monthly and quarterly records. For example, GDP index is commonly recorded in quarterly, PMI in monthly, while IHS Market car data in mixed of monthly, quarterly, and yearly. In the present example as depicted in FIG. 5a, the input data or index has a time scale or time series as 1) monthly, 2) quarterly and 2) a mixed time series of monthly and quarterly spanning across a time period defined from January 2017 till December 2019.

Further, as shown in FIG. 5b, the transform module 404 executing the method steps 204, 304 acts as a Transform for index or time-scale to transform index data with mixed high and low time-scale into uniformed high granularity.

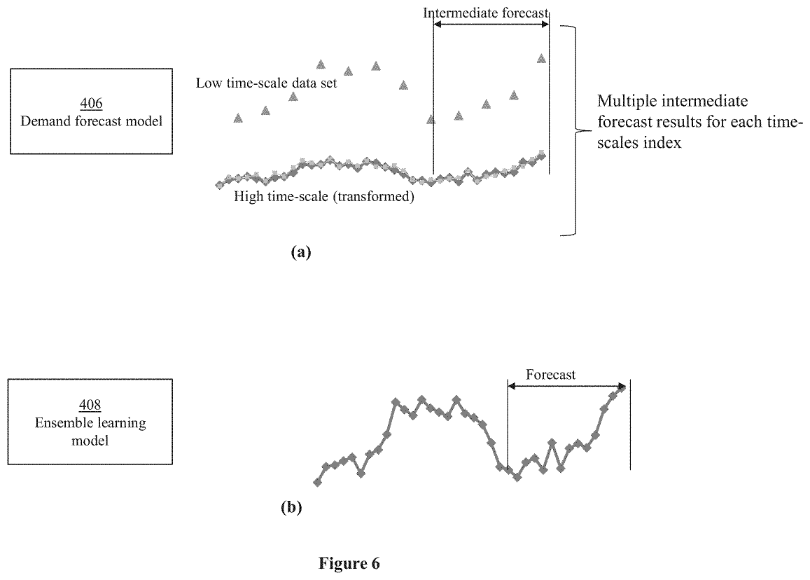

FIG. 6 illustrates the modules 406 and 408 as illustrated in FIG. 4. FIG. 6a depicts the demand forecasting module 406, which is executing the steps 206, 306 depicted in FIG. 6a conducts forecast by multiple forecast model or different forecast models. The different forecast models include one or multiple forecast results with each forecast model (hyperparameter selection, featuring engineering, etc). One set of the same time-scales index data generate the same time-scale target forecast.

FIG. 6b illustrates the ensemble learning module 408 executing the steps 208, 308 for ensembling results from different models and of different time scales to generate a final forecast of high time scale index or time series of large granularity among the input indexes.

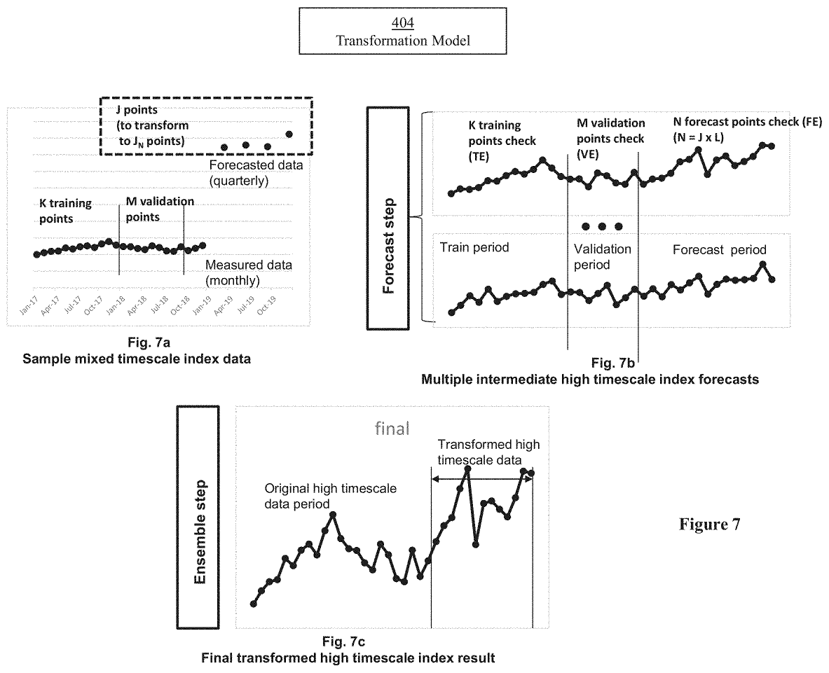

FIG. 7 illustrates the transformation-module 404 operation as a sequential operation through the representations provided in FIG. 7a, FIG. 7b and FIG. 7c.

FIG. 7a represents the output of data capturing module 402 and accordingly represents input data set or indexes for the module 404. In an example, measured data represents ‘monthly measured record for products in a time span starting from January 2017 till December 2018, and ‘quarterly forecast’ for the time period January 2019 till December 2019. Overall, index data source providers may offer different format of data. This represents heterogeneous timescale input data for the model.

In the present example, the quarterly data (i.e. J points) corresponds to a low time scale and is proposed to be transformed to monthly data (J_{N} points). Accordingly, FIG. 7b represents a forecasting step wherein multiple intermediate high timescale index forecasts are done with respect to the monthly measured data of FIG. 7a. Specifically, the forecast step generates multiple monthly forecast from monthly records by a set of machine learning, time series models, deep learning (LSTM, RNN, . . . ) etc.

FIG. 7c represents achieving a final transformed high timescale index result. A set of monthly forecast from FIG. 7b is selected according to multiple criteria. Examples of model selection criteria include training/validation error, forecast error, a function based on error such as a sophisticated function based on error and variance of error. In an example, model selection criteria examples may be provided as follows:

$$\begin{matrix}αTE\_MAPE ( i ) + βVE\_MAPE ( i ) + γFE\_MAPE ( i ) < threshold\_MAPE , & i . \\ and or & \\ \sqrt[2]{αTE\_MAPE {( i )}^{2} + βVE\_MAPE {( i )}^{2} + γFE\_MAPE {( i )}^{2}} < threashold\_MAPE , & ii . \\ and or & \\ αTE\_Var ( i ) + βVE\_Var ( i ) + γFE\_Var ( i ) < threshold\_VAR , and or & iii . \\ Percentile of MAPE ( TE , VE , FE ) and or VAR ( TE , VE , FE ) & iv . \\ Any other combinations of errors & v . \\ Note : α + β + γ = 1 & \end{matrix}$$

The aforesaid example errors such as training error, validation error, forecast error (TE, VE, FE), and optimized objective functions based on said errors such mean absolute error percentage (MAPE), mean absolute error (MAE), Model error variance (VAR), may be depicted as follows in following Table 1:

TABLE 1
Model i error definitions

```
Training Error (TE) at point k: eᵢ^{k} = |forecast_k_i − actual_k|
Validation Error (VE) at point m: eᵢ^{m} = |forecast_m_i − actual_m|
Forecast Error (FE) at point j: eᵢ^{j} = |forecast_j_i − actual j|
forecast_j_i = Σ_{n=[j-1, j]×L} forecast_n_i (add up high timescale forecasts
[(j-1)xL, jxL] according to low timescale real data j)
Mode i MAPE (mean absolute error percentage) for TE, VE, FE:
  $TE ( VE , FE ) \_MAPE ( i ) = \frac{1}{N} {\sum }_{N} \frac{\vert forecast\_n - actual\_n \vert}{actual\_n}$
MAE (mean absolute error) for TE, VE, FE:
  $TE ( VE , FE ) \_MAE ( i ) = \frac{1}{N} {\sum }_{N} \vert forecast\_n - actual\_n \vert$
  $Mode i Error variance \text{:} TE ( VE , FE ) \_Var ( i ) = \frac{1}{N} {\sum }_{N} {( {e}_{i}^{n} )}^{2}$
```

Examples of optimized functions based on errors may be Percentile of MAPE (TE, VE, FE) and or VAR (TE, VE, FE), any other possible combinations of errors, any other functions/derivations of errors or any possible combination of functions/derivations of errors. In order to enable a manual selection among aforesaid different types of errors or among different optimized functions, a GUI may be provided.

Thereafter and a part of operation of FIG. 7c, an ensemble modelling approach is used to integrate the set of monthly forecasts from FIG. 7a into one single monthly forecast based on aforesaid model-selection criteria as depicted. The original quarterly index of FIG. 7a may be used as one of the key references for the ensemble.

An example ensemble learning example has been depicted in following Table 2

TABLE 2

| | | |
|---|---|---|
| Step 1. | Minimize | Minimize {Σᵢ αᵢ × VE_MAPE(0)} to obtain |
| Optimize | VE MAPE | {α₁, α₂, αₘ} |
| options | Minimize | 1. Minimize {Σᵢ αᵢ × (α × VE_MAPE(i) + β × |
| | VE & FE | FE_MAPE(i)} to obtain (α₁, α₂, αₘ), α, β |
| | MAPE | by default or user defined. |
| | Minimize | 1. Minimize {Σᵢ αᵢ × (α × VE_MAPE(i) + β × |
| | VE & FE | FE_MAPE(i) + γ × VE_Var(i))} to obtain |
| | MAPE + VE | {α₁, α₂, αₘ}, α, β, γ by default or user |
| | Variance | defined. |
| | Any other | Any other optimization functions |
| | optimization | |
| | functions | |

| | |
|---|---|
| Step 2. | 2. Ensemble model_forecast_n = Σᵢ αᵢ × |
| Ensemble and result | forecast_n_i |
| adjustment | 3. Adjust forecast_n according to real data |
| | (original quarterly data in FIG. 7a ) |
| | forecast_n = model_ forecast _n × |
| | $forecast\_n = model\_forecast \_n \times \frac{original\_j}{{\sum }_{n = [ j - 1 , j ] \times L} model\_forecast \_n}$ |
| | Model forecasts [(j-1)xL, jxL] are corresponding to original |
| | $low timescale data original\_j \cdot j = ⌊ \frac{n}{L} ⌋$ |

As may be understood from Table 2 and Step 2, the adjusted forecast_n as calculated refers the Final transformed high timescale index result as depicted in FIG. 7c. Overall, the transformation result is predicted as an ensemble-model result from the plurality of intermediate transformation results using one or more functions of error values of the plurality of training data points, the error values of the plurality of validation data points, and the original low time scale input in FIG. 7a.

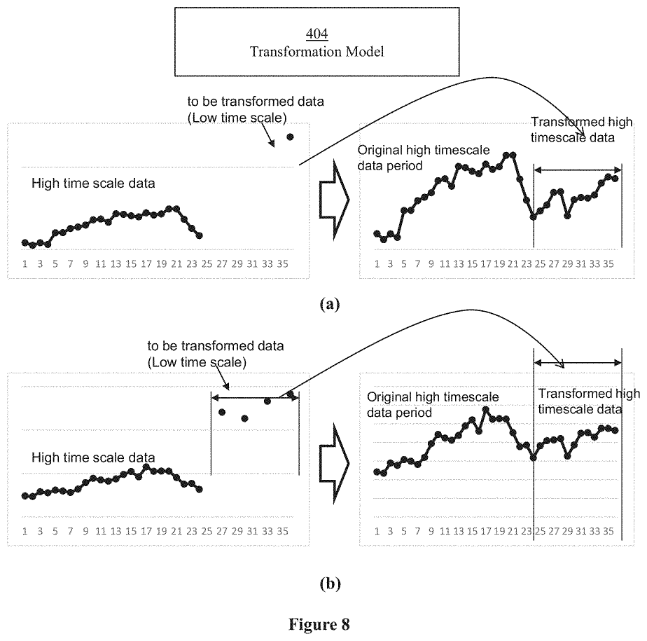

FIG. 8 refers other example sample of data transforms as produced with respect to FIG. 7c by the transformation module 404. More specifically, FIG. 8a and FIG. 8b depict transformation of different type of low time scale data forming a part of heterogeneous input to the data capturing module 402 into high time scale. Overall, the transformation module 404 enables pre-processing of the forecast data available in different timescale to unify them in a uniform timescale

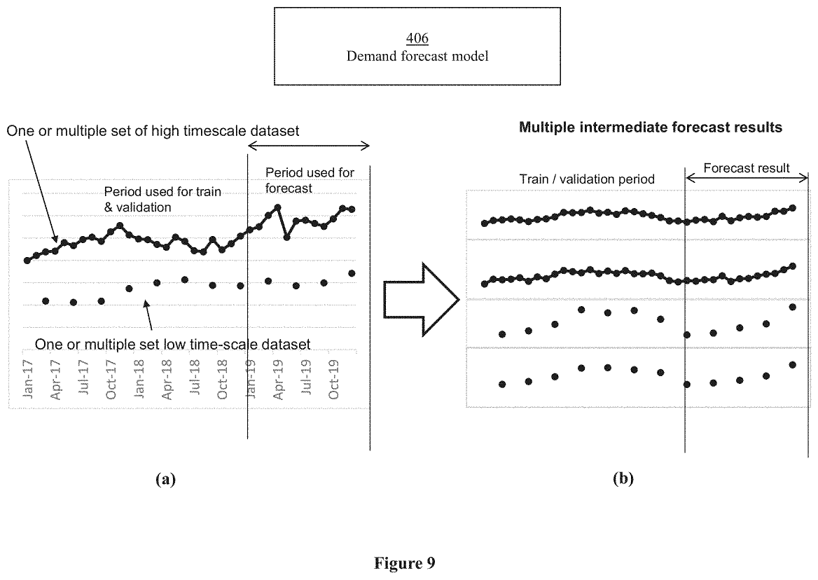

FIG. 9 illustrates an example operation of data forecast module 406 executing the steps 208 and 308. FIG. 9a represents the transformed result of FIG. 7c and comprises one or multiple set of high timescale dataset. Other data set may be one or multiple set of low timescale dataset as originally present in FIG. 5a. Accordingly, FIG. 9b represents obtaining multiple intermediate forecast results from FIG. 9a based on multiple or different types of forecast models (machine-learning and time series models) such as linear models, Random forest, Gradient boost, Deep learning (LTSM, RNN) for results generation.

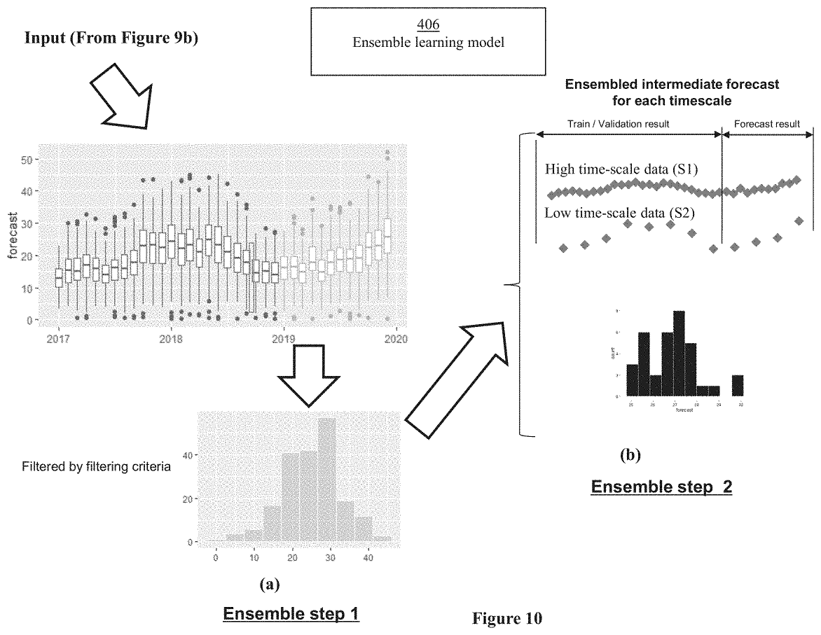

FIG. 10 illustrates an operation of the ensemble learning module 408 based on “Multiple intermediate forecast” results as obtained in FIG. 9b.

As a part of ensemble step 1, multiple-forecasts for each time-series or time domain input are considered as first intermediate results as rendered from FIG. 9b. Thereafter a model-selection criteria is applied to filter forecasts or select second intermediate results from the first intermediate results, wherein the training error (TE) or validation error (FE) or forecast difference (FD) may be considered as the criteria.

In an example, Model-selection criteria examples may include

$$\begin{matrix}αTE\_MAPE ( i ) + βVE\_MAPE ( i ) < threashold\_MAPE , and or & i . \\ \sqrt[2]{αTE\_MAPE {( i )}^{2} + βVE\_MAPE {( i )}^{2}} < threashold\_MAPE , and or & ii . \\ αTE\_Var ( i ) + βVE\_Var ( i ) + γFD\_Var ( i ) < threashold\_VAR , and or & iii . \\ Percentile of MAPE ( TE , VE ) and or VAR ( TE , VE ) & iv . \\ Any other combinations of errors Note : α + β = 1 or α + β + γ = 1 & v .\end{matrix}$$

The following Table 3 represents example Model i error definitions:

TABLE 3

| Errors | Model i error definitions |
|---|---|
| Training Error (TE) | Training Error (TE) at point k: eᵢ^{k} = |
| | \|forecast_k_i − actual_k\| |
| Validation Error (VE) | Validation Error (VE) at point m: eᵢ^{m} = |
| | \|forecast_m_i − actual_m\| |
| Forecast Difference (FD) | Forecast Difference (FD) at point n: eᵢⁿ = |
| | \|forecast_n_i − forecast_n_ref\| |
| | forecast_n_ref can be provided as reference to AI |
| | forecast in some scenarios, such as customer |
| | provided purchase forecast data |
| MAPE (mean absolute error | Mode i MAPE (mean absolute error percentage) for |
| percentage MAE (mean absolute error) | TE, VE, FE: $TE ( VE , FD ) \_MAPE ( i ) = \frac{1}{N} {\sum }_{N} \frac{\vert forecast\_n - actual\_n \vert}{actual\_n}$ |
| | MAE (mean absolute error) for TE, VE, FE: |
| | $TE ( VE , FD ) \_MAE ( i ) = \frac{1}{N} {\sum }_{N} \vert forecast\_n - actual\_n \vert$ |
| Mode i Error variance | $Mode i Error variance \text{:} TE ( VE , FD ) \_Var ( i ) = \frac{1}{N} {\sum }_{N} {( {e}_{i}^{n} )}^{2}$ |

Overall, as a part of ensemble step 1, a first type of distribution as box plots is generated for each time interval from the plurality of first intermediate forecast results. Optionally, a second type of distribution “histograms” may be generated from the first distribution. Based on said first or second distribution, the second intermediate forecast results are selected from the plurality of first intermediate prediction results based on a training error, a validation error, a forecast difference (if available), derivatives of said training and validation errors and forecast difference comprising an error variance, said errors and derivatives being associated with the plurality of first intermediate prediction results. In other example, the selection basis may be an objective optimization function of said training error, said validation error, the derivations of the training error and the validation error, and combinations thereof associated with the plurality of first intermediate prediction results. In yet another example, the selection basis may be a percentile setting associated with said second plurality of machine learning models and time series models.

As a part of ensemble Step 2, averaging is performed with respect to the each of the shortlisted time-domain forecasts in Ensemble step 1 to output one or more averaged time domain forecast that again may correspond to high time domain or low time domain. The averaging denotes computing a weighted-average based on a) validation error, b) sophisticated functions on training error, validation error, forecast difference (if applicable), or any combination, by the model ensemble based on weights for each selected model results at each data point. Overall, the generation of aggregated result comprises calculating a weighted-average of said shortlisted or the second intermediate forecast results to generate the final prediction result through ensemble step 3 as described later. The generated results as a part of present ensemble step 2 corresponds to generating a high time scale ensembled forecast and a low time scale ensembled forecast from the selected results.

An example Model ensemble example (sophisticated method) referring ensemble step 2 has been referred in below depicted Table 4.

TABLE 4

| | | |
|---|---|---|
| 1. Optimize | Minimize VE | 1. Minimize {Σᵢ αᵢ × VE_MAPE(i)}to obtain |
| options | MAPE | (α₁, α₂, αₘ) |
| (intermediate | Minimize VE & | 1. Minimize{Σᵢ αᵢ × (αVE_MAPE(i) + |
| forecast with | FD MAPE + | βFD_MAPE(i) + γ × VE_Var(i))} to obtain (α₁, α₂, |
| the same | VE Variance | αₘ), α, β, γ by default or user defined. |
| timescale | Minimize VE | Minimize{Σᵢ αᵢ × (αVE_MAPE(i) + |
| from FIG. | TE & FD | βTE_MAPE(i) + γFD_MAPE(i) + δVE_Var(i))} to |
| 9b) | MAPE + VE | obtain (α₁, α₂, αₘ), α, β, γ, δ by default or user |
| | Variance | defined. |
| | Any other | Any other optimization functions |
| | optimization | |
| | functions | |

| | |
|---|---|
| 2. Ensemble models for each | 2A. Ensemble model_forecast_n = Σᵢ αᵢ × |
| timescale forecast | forecast_n_i (A timescale, eg monthly) |
| | 2B. Ensemble model_forecast_n = Σᵢ βᵢ × |
| | forecast_n_i (B timescale, quarterly) |

Overall, the present ensemble steps 1 and 2 refer an ensemble of machine learning models to generate an empirical cumulative probability distribution of the forecast. Thereafter, an optimal range of percentile is chosen based on Table 3 and the forecasts of different time scales are computed through Table 4 by a weighted average of the different percentiles of the empirical cumulative probability distribution.

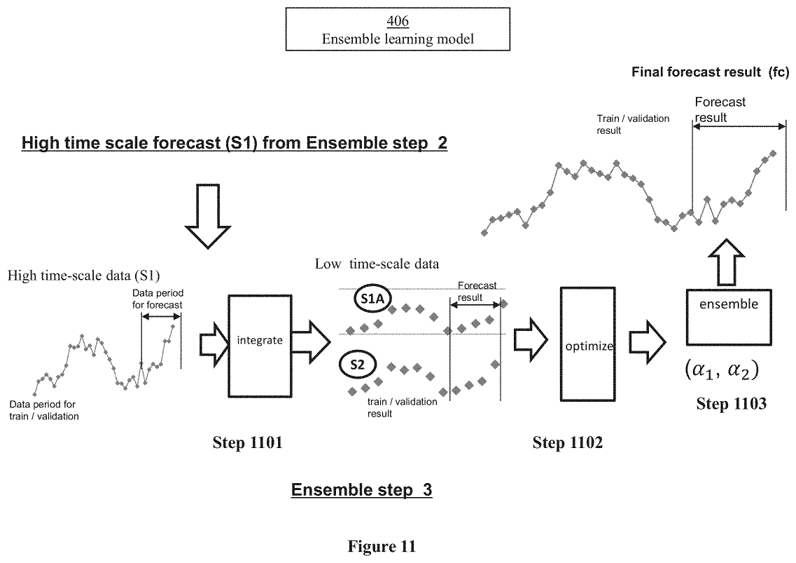

FIG. 11 illustrates an operation of ensemble learning module 408 and thereby depicts an ensemble step 3 based operation in continuation to ensemble step 2 operation of FIG. 10. More specifically, ensemble step 3 corresponds to a Low granularity forecast to adjust high time scale forecast (S1) from FIG. 10b based on training error, validation error, or both to decide the weight.

Following Table 5 depicts Ensemble models of different-timescale forecast in terms of sequence defined by steps 1101, 1102 and 1103

TABLE 5

| | | |
|---|---|---|
| Step | Integrate high | S1A(i) = Σ_{k=(i-j)*J}^{ij} S1(k), J is times of S1 high timescale to |
| 1101 | timescale to | low timescale, i.e., J = 3 month integrates to 1 quarter. |
| | low | |
| Step | Minimize VE | Minimize {Σᵢ αᵢ × VE_MAPE(i)} to obtain (α₁, α₂, αₘ) |
| 1102 | MAPE | |
| Optimize | Minimize VE | Minimize {Σᵢ αᵢ × (α + VE_MAPE(i) + β × TE_MAPE(i)) |
| options | & TE MAPE | to obtain (α₁, α₂, αₘ), α, β by default or user defined. |
| | Minimize VE | Minimize {Σᵢ αᵢ × (α + VE_MAPE(i) + β × TE_MAPE(i)) |
| | & TE MAPE | + γ × VE_Var(i))) to obtain (α₁, α₂, αₘ), α, β, γ by default |
| | + VE | or user defined. |
| | Variance | |
| | Any other | Any other optimization functions |
| | optimization | |
| | functions | |

| | |
|---|---|
| Step 1103 Ensemble models of same time-scale forecast | $fc ( n ) = S 1 ( n ) * \frac{S 1 A ( i ) \times {α}_{1} + S 2 ( i ) \times {α}_{2}}{S 1 A ( i )} , i = ⌊ \frac{n}{J} ⌋$ |

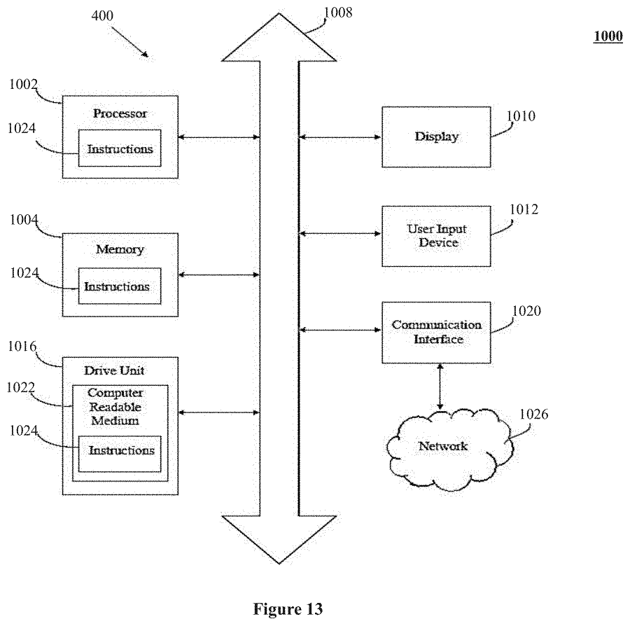

The aforesaid steps 1101 to 1103 have been also referred in the form of control flow as depicted in FIG. 13 and said sequential operation may be referred as follows

At step 1101, the high timescale (S1) as obtained from ensemble step 2 is integrated to low timescale data as follows

S1A(i)=Σ_{k=(i-1)*J}^{iJ}S1(k)

Wherein J is the times of S1 high timescale to low timescale, i.e., J=3 for 3 month integrates to 1 quarter.

At step 1102, optimization options as referred in Table 5 are executed to get parameters of (α₁, α₂). Specifically, the step 1102 corresponds to determining one or more weights based on any function of one or more of a training error, a validation error, the derivatives, and the combinations thereof associated with the corresponding machine learning models and time series models.

At step 1103, the parameters (α₁, α₂) of step 1102 are used to compute the final forecast result (fc) as:

$$f c ( n ) = S 1 ( n ) * \frac{S 1 A ( i ) \times {α}_{1} + S 2 ( i ) \times {α}_{2}}{S 1 A ( i )} , i = ⌊ \frac{n}{J} ⌋$$

More specifically, step 1104 refers adjustment of high time scale forecast S1(n) based on low time scale or Low granularity forecast S1(A) and S2 to compute the final forecast result (fc) as the high time scale forecast.

The present subject matter accordingly renders comprehensive-system architecture to transform and unify the predictors data on different timescale through the transformation module 404. Instead of a point forecast, the proposed approach makes a forecast interval that generates a probability distribution of demand forecast through an ensemble of many predictive models as provided by the demand forecast module 406, whereby the optimal forecast percentile is chosen by the ensemble learning module 408. As a result, the present subject matter is robust, adaptive and addresses the uncertainties generated in the forecast module 406 due to unification of regressors at different timescales. Moreover, such an approach enables incorporation of the domain expertise

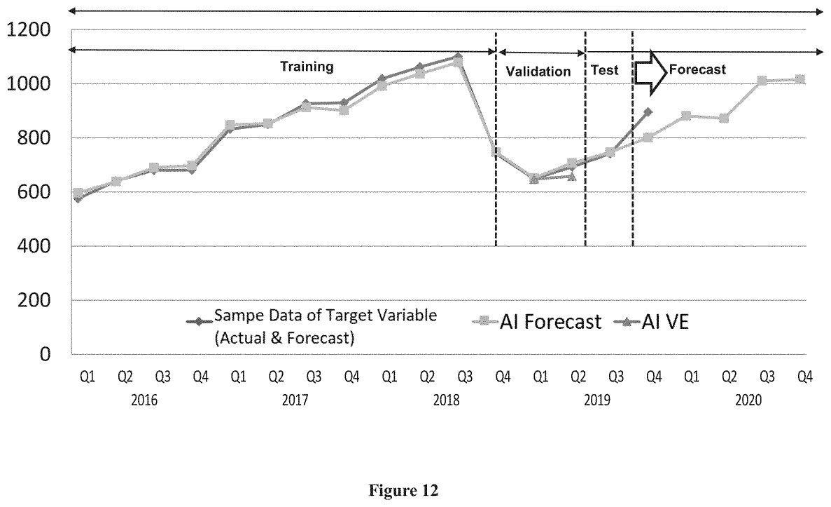

FIG. 12 illustrates example results of Forecast Improvement through the present subject matter. As depicted in the figures, the machine learning based forecast for the index closely follows the actual-measurements with the training, validating and testing error falling in the range defined by 1.9% to 2.6% as defined in the below mentioned Table 6.

TABLE 6

| | |
|---|---|
| Train Error | 1.9% |
| VE | 2.6% |
| Test Error | 2.0% |

Overall, the ML based system in accordance with the present subject system accepts heterogeneous timescale series data. In particular, the index data with lower timescale than the target product is allowed as input and accordingly improved forecast accuracy is provided by maximizing the use of valuable index data. At least based on transforming index data from low timescale to high timescale (e.g. quarterly to monthly, yearly to monthly) forecast may be made across a uniform timescale.

Based on the proposed approach to ensemble different timescale data into a uniform high timescale data, more accurate forecast by adaptively ensembling forecasts from multiple ML models with different timescales.

In addition, the present subject matter proposes interface to user, domain expert, to tune key parameters, such as optimal percentile setting, to improve forecast under high fluctuation scenarios.

FIG. 13 illustrates an implementation of the forecast system 400 as illustrated in FIG. 4 in a computing environment. The present figure essentially illustrates the hardware configuration of the system 400 in the form of a computer system 1000 is shown. The computer system 1000 can include a set of instructions that can be executed to cause the computer system 1000 to perform any one or more of the methods disclosed. The computer system 1000 may operate as a standalone device or may be connected, e.g., using a network, to other computer systems or peripheral devices.

In a networked deployment, the computer system 1000 may operate in the capacity of a server or as a client user computer in a server-client user network environment, or as a peer computer system in a peer-to-peer (or distributed) network environment. The computer system 1000 can also be implemented as or incorporated into various devices, such as a personal computer (PC), a tablet PC, a personal digital assistant (PDA), a mobile device, a palmtop computer, a laptop computer, a desktop computer, a communications device, a wireless telephone, a land-line telephone, a web appliance, a network router, switch or bridge, or any other machine capable of executing a set of instructions (sequential or otherwise) that specify actions to be taken by that machine. Further, while a single computer system 1000 is illustrated, the term “system” shall also be taken to include any collection of systems or sub-systems that individually or jointly execute a set, or multiple sets, of instructions to perform one or more computer functions.

The computer system 1000 may include a processor 1002 (e.g., a central processing unit (CPU), a graphics processing unit (GPU), or both. The processor 1002 may be a component in a variety of systems. For example, the processor 1002 may be part of a standard personal computer or a workstation. The processor 1002 may be one or more general processors, digital signal processors, application specific integrated circuits, field programmable gate arrays, servers, networks, digital circuits, analog circuits, combinations thereof, or other now known or later developed devices for analyzing and processing data The processor 1002 may implement a software program, such as code generated manually (i.e., programmed).

The computer system 1000 may include a memory 1004, such as a memory 1004 that can communicate via a bus 1008. The memory 1004 may be a main memory, a static memory, or a dynamic memory. The memory 1004 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory 1004 includes a cache or random access memory for the processor 1002. In alternative examples, the memory 1004 is separate from the processor 1002, such as a cache memory of a processor, the system memory, or other memory. The memory 1004 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1004 is operable to store instructions executable by the processor 1002. The functions, acts or tasks illustrated in the figures or described may be performed by the programmed processor 1002 executing the instructions stored in the memory 1004. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 1000 may or may not further include a display unit 1010, such as a liquid crystal display (LCD), an organic light emitting diode (OLED), a flat panel display, a solid state display, a cathode ray tube (CRT), a projector, a printer or other now known or later developed display device for outputting determined information. The display 1010 may act as an interface for the user to see the functioning of the processor 1002, or specifically as an interface with the software stored in the memory 1004 or in the drive unit 1016.

Additionally, the computer system 1000 may include an input device 1012 configured to allow a user to interact with any of the components of system 1000. The input device 1012 may be a number pad, a keyboard, or a cursor control device, such as a mouse, or a joystick, touch screen display, remote control or any other device operative to interact with the computer system 1000.

The computer system 1000 may also include a disk or optical drive unit 1016. The disk drive unit 1016 may include a computer-readable medium 1022 in which one or more sets of instructions 1024, e.g. software, can be embedded. Further, the instructions 1024 may embody one or more of the methods or logic as described. In a particular example, the instructions 1024 may reside completely, or at least partially, within the memory 1004 or within the processor 1002 during execution by the computer system 1000. The memory 1004 and the processor 1002 also may include computer-readable media as discussed above.

The present invention contemplates a computer-readable medium that includes instructions 1024 or receives and executes instructions 1024 responsive to a propagated signal so that a device connected to a network 1026 can communicate voice, video, audio, images or any other data over the network 1026. Further, the instructions 1024 may be transmitted or received over the network 1026 via a communication port or interface 1020 or using a bus 1008. The communication port or interface 1020 may be a part of the processor 1002 or may be a separate component. The communication port 1020 may be created in software or may be a physical connection in hardware. The communication port 1020 may be configured to connect with a network 1026, external media, the display 1010, or any other components in system 1000 or combinations thereof. The connection with the network 1026 may be a physical connection, such as a wired Ethernet connection or may be established wirelessly as discussed later. Likewise, the additional connections with other components of the system 1000 may be physical connections or may be established wirelessly. The network 1026 may alternatively be directly connected to the bus 1008.

The network 1026 may include wired networks, wireless networks, Ethernet AVB networks, or combinations thereof. The wireless network may be a cellular telephone network, an 802.11, 802.16, 802.20, 802.1Q or WiMax network. Further, the network 1026 may be a public network, such as the Internet, a private network, such as an intranet, or combinations thereof, and may utilize a variety of networking protocols now available or later developed including, but not limited to TCP/IP based networking protocols.

In an alternative example, dedicated hardware implementations, such as application specific integrated circuits, programmable logic arrays and other hardware devices, can be constructed to implement various parts of the system 1000.

Terms used in this disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description of embodiments, claims, or drawings, should be understood to contemplate the possibilities of including one of the terms, either of the terms or both terms. For example, the phrase “A or B” should be understood to include the possibilities of “A” or “B” or “A and B.”

All examples and conditional language recited in this disclosure are intended for pedagogical objects to aid the reader in understanding the invention and the concepts contributed by the inventor to furthering the art and are to be construed as being without limitation to such specifically recited examples and conditions. Although embodiments of the present disclosure have been described in detail, it should be understood that various changes, substitutions, and alterations could be made thereto without departing from the spirit and scope of the present disclosure.

1. A method for forecasting demand with respect to an entity, said method comprising:
receiving a plurality of input data-sets associated with time-series data, wherein each of said data-sets refers a time-based variation of one or more variables in accordance with a designated time-interval;
generate at-least one transformation-result by transforming time-intervals of at least one input dataset based on a plurality of time interval transformation models;
predicting a plurality of first intermediate forecast results based on a plurality of demand forecasting models from the at-least one transformation result, and
generating an aggregated result from the plurality of the first intermediate forecast results through an ensemble-model to thereby render said aggregated result as a final prediction result.

2. The method as claimed in claim 1, wherein the transformation of the time-intervals of the input data-set comprises unifying the time-intervals across the time intervals of the input dataset based on the plurality of time-interval transformation models.

3. The method as claimed in claim 1, wherein the input-dataset is a set of distinct time-interval based data sets defined by a first input dataset and a second input dataset, wherein the second input dataset has a larger time-interval than the first dataset and accordingly defines a lower time granularity than the first data set.

4. The method as claimed in claim 3, wherein said transforming comprises transforming a time interval of the second input dataset similar to a time interval of the first input dataset based on the plurality of time interval transformation models.

5. The method as claimed in claim 4, wherein the first input data set comprises a plurality of learning data points and a plurality of validation data points, and
wherein the plurality of time interval transformation models predict a plurality of intermediate transformation results based on the plurality of training data points, and the plurality of validation data points.

6. The method as claimed in claim 5, wherein the transformation result is predicted as an ensemble-model result from the plurality of intermediate transformation results using one or more functions of error values of the plurality of training data points, the error values of the plurality of validation data points, and the second input dataset.

7. The method as claimed in claim 5, wherein the plurality of demand prediction models predict the plurality of first intermediate forecast results based on at-least one of:
the transformation result; and
the transformation result and a third-input dataset having the same or different time interval than the transformation result.

8. The method as claimed in claim 6, wherein the prediction of the aggregated result to render the final prediction result based on the ensemble model comprises the steps of:
selecting a plurality of second intermediate forecast results from the plurality of first intermediate forecast results; and
generating the aggregated result by combining the plurality of second intermediate prediction results.

9. The method as claimed in claim 8, wherein said selecting of the plurality of second intermediate prediction results comprises:
generating a first type of distribution for each time interval from the plurality of first intermediate forecast results;
optionally generating a second type of distribution from the first distribution, and
based on said first or second distribution, selecting the second intermediate forecast results from the plurality of first intermediate prediction results based on one or more of:
a training error, a validation error, a forecast difference, derivatives of said training and validation errors and forecast difference comprising an error variance, said errors and derivatives being associated with the plurality of first intermediate prediction results, and
an objective optimization function of said training error, said validation error, said forecast difference, the derivations of the training error and the validation error, and forecast difference, and combinations thereof associated with the plurality of first intermediate prediction results.

10. The method as claimed in claim 8, wherein generating the aggregated result comprises calculated a weighted-average of the second intermediate forecast results to generate the final prediction result.

11. The method as claimed in claim 1, wherein the first input dataset and second data set related to different timescales correspond to one or more of a monthly index, a quarterly index, an yearly index, any miscellaneous time-scale index.

12. A method for forecasting for time-series based dataset, said method comprising:
receiving a plurality of input data-sets associated with time-series data, wherein each of said data set refers a time-based variation of one or more variables in accordance with a designated time-scale;
transforming a time-scale of at-least one of said plurality of data sets based on at least one time-scale transformation model to generate at-least one transformed dataset;
predicting a plurality of intermediate prediction results based on a plurality of demand forecasting models from at-least one of:
at-least one transformed dataset; and
at least one input data set other than the transformed data set; and
generating an aggregated prediction-result from the plurality of the intermediate prediction results based on an ensemble-learning model.

13. The method as claimed in claim 12, wherein said at-least one transformed dataset is associated with a higher time scale out of the heterogeneous time-scales associated with the received input data-sets and accordingly defines a higher time granularity among the heterogeneous time-scales associated with the received input data-sets.

14. The method as claimed in claim 12, wherein the transforming of the time-scale of the at least one input data set through the transformation model comprises:
executing a first plurality of machine-learning and time series models over the at least one input data set to obtain a plurality of intermediate transformation data sets; and
executing an ensemble-learning model for aggregating the plurality of intermediate transformation data sets set to obtain an aggregated output as said at-least one transformed data set.

15. The method as claimed in claim 12, wherein the predicting of plurality of intermediate prediction results from the transformed data set comprises executing a second plurality of machine-learning and time series models over the at least one transformed data set and the at least one input data set to obtain said intermediate prediction results.

16. The method as claimed in claim 15, generating an aggregated prediction-result based on the ensemble-learning model comprises:
selecting at least a subset of said intermediate prediction results based on any function of training error, validation error, derivatives of said errors, combinations thereof, and a percentile setting associated with said second plurality of machine learning models and time series models;
generating a high time scale ensembled forecast and a low time scale ensembled forecast from the selected prediction result; and
generating a final high time-scale forecast result based on adjustment of the high time scale ensembled forecast by the low time scale ensembled forecast.

17. The method as claimed in claim 16, generating said final high time-scale forecast result comprises:
integrating the high time scale ensembled forecast into a corresponding low-time scale ensembled forecast;
determining one or more weights based on any function of one or more of a training error, a validation error, the derivatives, the combinations thereof associated with the second plurality of machine learning models and time series models;
adjusting the high time scale ensembled forecast based on one or more low time scale ensembled forecasts and said one or more weights; and
generating the final high time-scale forecast as the adjusted high time scale ensembled forecast.

18. A system for forecasting demand with respect to an entity, said method comprising:
a receiving module configured for receiving a plurality of input data-sets associated with time-series data, wherein each of said data-sets refers a time-based variation of one or more variables in accordance with a designated time-interval;
a transformation model configured to generate at-least one transformation-result by transforming time-intervals of at least one input dataset;
a plurality of demand forecasting models for predicting a plurality of first intermediate forecast results based on at-least one transformation result, and
an ensemble-learning model for generating an aggregated result from the plurality of the first intermediate prediction results through an ensemble-model to thereby render said aggregated result as a final prediction result as.

19. The system as claimed in claim 18, wherein the transformation model is configured to predict the transformation result as an ensemble-model result from a plurality of intermediate transformation results using one or more functions of error values of the plurality of training data points, the error values of the plurality of validation data points, and the second input dataset.

20. The system as claimed in claim 18, wherein the ensemble-learning model is configured for the prediction of the aggregated output to render the final prediction result based on:
selecting a plurality of second intermediate prediction results from the plurality of first intermediate prediction results; and
generating the aggregated result by combining the plurality of second intermediate prediction results.
